(19) United States
(12) Patent Application Publication
(10) Pub. No.: US 2025/0247096 A1
(43) Pub. Date: Jul. 31, 2025

(54) MICROCELL LIBRARY FOR IMPLEMENTATION OF COMPUTATIONAL LOGIC USING DIGITAL VLSI SYSTEMS

(71) Applicant: Uma Pandey, Hamirpur (IN)

(72) Inventors: Kumar Sambhav Pandey, Hamirpur (IN); Hitesh SHRIMALI, Mandi (IN)

(21) Appl. No.: 18/878,667

(22) PCT Filed: May 25, 2023
(86) PCT No.: PCT/IN2023/050498

§ 371 Date: Dec. 24, 2024

(30) Foreign Application Priority Data
May 25, 2022 (IN) 202211030038

(51) Int. Cl. H03K 19/00; H03K 19/20

(52) U.S. Cl. CPC H03K 19/0008; H03K 19/20

(57) ABSTRACT

A microcell library including a plurality of microcells is provided for implementing subscalar digital arithmetic computing paradigm. Each of the plurality of microcells may implement a primitive logic and has a uniform interface with three input operands at an input interface and two output operands at an output interface. The two output operands in a clock cycle are latched to one or more output registers. Each microcell is configured to perform one of a partial arithmetic operation based on the three input operands to generate the two output operands, or a logical operation based on at least two of the three input operands to generate at least one of the two output operands. Each of the three input operands and each of the two output operands have a uniform pre-defined valency.

### CROSS-REFERENCE INFORMATION

This application is a national phase of Indian PCT Application No. PCT/IN2023/050498 titled “MICROCELL LIBRARY FOR IMPLEMENTATION OF COMPUTATIONAL LOGIC USING DIGITAL VLSI SYSTEMS” which claims priority to the Indian provisional patent application No. 202211030038, filed May 25, 2022, entitled “IMPLEMENTATION OF DIGITAL INTEGRATED CIRCUITS ORGANIZED AS SUBSCALAR ARCHITECTURES COMPOSED OF MICRO-CELL LIBRARY BLOCKS” both of which are hereby incorporated by reference in its entirety.

### TECHNICAL FIELD

The instant disclosure relates to a method and system for defining cell libraries for designing ASIC (application specific integrated circuit) implementing computational logic in very large scale integrated (VLSI) system.

### BACKGROUND

In semiconductor design, standard-cell methodology is used to design application-specific integrated circuits (ASICs) with mostly pre laid out digital-logic gates. Standard-cell methodology is an example of design abstraction, whereby a low-level very-large-scale integration (VLSI) layout is encapsulated into an abstract logic representation (such as a NAND gate). Using standard-cell methodology, ASICs have been scaled from comparatively simple single-function ICs (of several thousand gates), to complex multi-million gate system-on-a-chip (SoC) devices which are used in personal computers, graphic cards, digital cameras, smart devices, etc. These computing structures implement computational logic which are implemented using a number of transistors. Their processing throughput depends greatly on the computational logic and the number of transistors being used. Further, parallelism is one of the key mechanisms for enhancing the processing throughput. It is known in the art that the presence of data-flow dependencies adversely impacts the exploitation of such parallelism. The performance of digital systems cannot be arbitrarily enhanced merely by way of exploiting parallelism at data-word boundaries in presence of such data-flow dependencies. A deeper inspection and research on the architectures of arithmetic computing structures, reveal that neither all the bits of the result are produced simultaneously nor do all the bits of operands are consumed simultaneously in any logical operation. Further, some implementations in prior art, operate on operands with less precision in order to be faster and to consume less silicon resources by way of compromising on data width in one way or the other.

Therefore, there is a requirement to develop cell libraries which may help implement a computational methodology utilizing parallelism in a manner that is resource friendly and allows processing with higher efficiency and speed.

### SUMMARY

In an embodiment, a microcell library including a plurality of microcells is provided. In an embodiment, each of the plurality of microcells may implement a primitive logic and may have a uniform interface with three input operands at an input interface and two output operands at an output interface. In an embodiment, the two output operands, for each of the plurality of microcells, in a clock cycle may be latched to one or more output registers of the corresponding microcell. In an embodiment, each of the plurality of microcells may be configured to perform a partial arithmetic, bit-wise logic, shift or control-flow operation based on the three input operands to generate the two output operands. In an embodiment, each of the three input operands and each of the two output operands have a uniform predefined valency.

In an embodiment, the uniform pre-defined valency may be selected from a pair (2-bits), a nibble (4-bits), a byte (8-bits), a half-word (16-bits), or an integer power of 2.

In an embodiment, an implementation of each of the plurality of microcells may be pipelined or unpipelined.

In an embodiment, one or more of the plurality of microcells may be connected in series, parallel or cascade topologies for performing arithmetic, logic, shift, controlflow or any combination thereof operation at a data-width higher than the pre-defined valency. In an embodiment, at least one of the plurality of microcells may be configured to perform a bit-wise logic operation. In an embodiment, the logic operation may be a bit-wise unary operation or a bit-wise binary operation. In an embodiment, for performing the logic operation, the at least one of the plurality of microcells may be configured to perform a logic operation on at least one of a first input operand and/or a second input operand based on a third input operand to output a first output operand of the two output operands based on the logic operation and a second output operand of the two output operands as a copy of the third input operand. In an embodiment, the logic operation is one of: a complement of one of the first input operand or the second input operand, an AND of the first input operand and the second input operand, an OR of the first input operand and the second input operand, or an EX-OR of the first input operand and the second input operand respectively in case the third input operand is Boolean value of 0, 1, 2, or 3 to represent NOT, AND, OR and EX-OR operations respectively. In an embodiment, in case of NOT operation the second input is ignored.

In an embodiment, at least one of the plurality of microcells may be configured to perform a bit-wise shift operation. In an embodiment, for performing the bit-wise shift operation, the at least one of the plurality of microcells may be configured to perform a bit-wise left shift operation the at least two output operands are a bit-wise left shift of a first input operand or a second input operand from the three input operands based on a number of bit-positions represented by a third input operand from the three input operands.

In an embodiment, at least one of the plurality of microcells may be configured to perform a mask operation. In an embodiment, for performing the mask operation, the at least one of the plurality of microcells may be configured to output a corresponding bit value of a place value of a first input operand of the three input operands as a first output operand from the two output operands based on a place value specified by a second input operand from the three input operands.

In an embodiment, at least one of the plurality of microcells may be configured to perform a partial addition operation. In an embodiment, for performing the partial addition operation, the at least one of the plurality of microcells may be configured to output the sum of the three input operands as the two output operands. In an embodiment, a first output operand from the two output operands may represent the sum output, and wherein a second output operand from the two output operands may represent a carry-out of the sum.

In an embodiment, at least one of the plurality of microcells may be configured to perform a partial subtraction operation. In an embodiment, for performing the partial subtraction operation, the at least one of the plurality of microcells may be configured to output a difference by subtracting a second input operand and a third input operand from a first input operand from the three input operands. In an embodiment, a first output operand from the two output operands may represent the difference output as 2's compliment representation, and wherein a second output operand from the two output operands may represent a borrow-out of the difference.

In an embodiment, at least one of the plurality of microcells may be configured to perform a partial multiply-add operation. In an embodiment, for performing the partial multiply-add operation, the at least one of the plurality of microcells may be configured to output the product of a first input operand and a second input operand added to a third input operand from the three input operands, wherein a first output operand from the two output operands may represent a lower half significant bits of the output, and wherein a second output operand from the two output operands may represent an upper half significant bits of the output.

In an embodiment, at least one of the plurality of microcells may be configured to perform a compare operation. In an embodiment, for performing the compare operation, the at least one of the plurality of microcells may be configured to output a first output operand as “0” in case a first input operand may be determined equal to a second input operand from the three input operands and in case a third input operand from the three input operands may be determined equal to “0”.

In another embodiment, the at least one of the plurality of microcells may be configured to output the first output operand as “1” in case the first input operand may be determined greater than or in case first input operand may be determined equal to the second input operand and the third input operand may be determined equal to “1”. In yet another embodiment, the at least one of the plurality of microcells may be configured to output the first output operand as “2” in case the first input operand may be determined less than or in case first input operand may be determined equal to the second input operand and the third input operand may be determined equal to “2”.

In an embodiment, at least one of the plurality of microcells may be configured to perform a multiplexing operation. In an embodiment, for performing the multiplexing operation, the at least one of the plurality of microcells may be configured to output a first output operand from the two output operands equal to a first input operand from the three input operands in case a third input operand from the three input operands comprises “0” in each place values, or the at least one of the plurality of microcells may be configured to output the first output operand equal to a second input operand from the three input operands in case the third input operand comprises “1” in each place values. The third input operand is copied to the second output operand.

In an embodiment, at least one of the plurality of microcells may be configured to perform a de-multiplexing operation. In an embodiment, for performing the de-multiplexing operation, the at least one of the plurality of microcells may be configured to output a first output operand from the two output operands equal to a first input operand from the three input operands in case a third input operand from the three input operands comprises “0” in each place value, or the at least one of the plurality of microcells may be configured to output a second output operand from the two output operands equal to the first input operand in case the third input operand comprises “1” in each place values.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, explain the disclosed principles.

FIG. 1 illustrates a microcell of a microcell library, in accordance with an embodiment of the present disclosure.

FIG. 2A illustrates a logic microcell of the microcell library, in accordance with an exemplary embodiment.

FIG. 2B illustrates an exemplary implementation of a 2-bit logic microcell 200B using NAND gates, in accordance with an embodiment of the present disclosure.

FIG. 3A illustrates a shift microcell of the microcell library, in accordance with an exemplary embodiment.

FIG. 3B illustrates an exemplary implementation of a 2-bit shift microcell using NAND gates, in accordance with an embodiment of the present disclosure.

FIG. 4A illustrates a mask microcell of the microcell library, in accordance with an embodiment of the present disclosure.

FIG. 4B illustrates an exemplary implementation of a 2-bit mask microcell using NAND gates, in accordance with an embodiment of the present disclosure.

FIG. 5A illustrates a partial adder microcell of the microcell library, in accordance with an embodiment of the present disclosure.

FIG. 5B illustrates an exemplary implementation of a 2-bit partial adder microcell using NAND gates, in accordance with an embodiment of the present disclosure.

FIG. 6A illustrates a partial subtractor microcell of the microcell library, in accordance with an embodiment of the present disclosure.

FIG. 6B illustrates an exemplary implementation of a 2-bit partial subtractor microcell using NAND gates, in accordance with an embodiment of the present disclosure.

FIG. 7A illustrates a partial multiply-add microcell of the microcell library, in accordance with an embodiment of the present disclosure.

FIG. 7B and FIG. 7C illustrate an exemplary implementation of a 2-bit partial multiplier microcell using NAND gates, in accordance with an embodiment of the present disclosure.

FIG. 8A illustrates a compare microcell of the microcell library, in accordance with an embodiment of the present disclosure.

FIG. 8B illustrates an exemplary implementation of a 2-bit compare microcell using NAND gates, in accordance with an embodiment of the present disclosure.

FIG. 9A illustrates a mux microcell of the microcell library, in accordance with an embodiment of the present disclosure.

FIG. 9B illustrates an exemplary implementation of a 2-bit mux microcell using NAND gates, in accordance with an embodiment of the present disclosure.

FIG. 10A illustrates a demux microcell of the microcell library, in accordance with an embodiment of the present disclosure.

FIG. 10B illustrates an exemplary implementation of a 2-bit demux microcell using NAND gates, in accordance with an embodiment of the present disclosure.

FIG. 11A, FIG. 11B and FIG. 11C illustrates area-throughput figure-of-merit (FOM) for the unpipelined, pipelined, and subscalar implementations at pair, nibble, and byte valencies of the chosen benchmark circuits are plotted as histograms for an 8-bit, 16-bit, 32-bit data-path widths, in accordance with an experimental embodiment of the present disclosure.

### DETAILED DESCRIPTION

The present invention presents a cell library at an abstraction that is higher than that of standard cells, but lower than macro cells.

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the scope of the disclosed embodiments. It is intended that the following detailed description be considered as exemplary only, with the true scope being indicated by the following claims. Additional illustrative embodiments are listed below.

A subscalar operation operates on sub-atomic data fragments and performs only partial operations on them. The atomic data and atomic operations are broken down into sub-atomic data fragments and sub-atomic partial operations respectively. Such a break-up exposes hitherto unexploited levels of parallelism by way of allowing overlap of operations even if they are data dependent. Applicants have found that the improved exploitation of latent parallelism to enhance processing throughputs comes with a favourable impact on the area-power characteristics of corresponding computing structures. A number of these subscalar instructions are connected in series, parallel, cascade or compound topologies to perform an atomic operation on atomic data. As these subscalar operations or instructions operate on sub-atomic data fragments, even data-flow dependent operations may be temporally overlapped, thereby giving rise to a new and novel concept of sub-instruction level parallelism (SILP).

In a pipelined subatomic implementation, using a single instance of the implementation unit, the atomic operations may be computed by splitting each of the atomic operations into one or more sub-atomic operations. In an embodiment, an atomic operation may be split into sub-atomic operations based on a complexity level of the atomic operation and time required to perform each of the subatomic operations. Accordingly, one or more of the subatomic operations may be computed in one clock cycle and any atomic operation may be implemented in a pipelined manner by interconnections of micro-cells claimed in this invention. Further, the computation of each atomic operation may be done by operating on their corresponding atomic input operands or atomic datum which may be split into two or more sub-word or sub-atomic data fragments. In an embodiment, the valency of the subatomic data fragment may be equal to 1 bit, 2 bit, 4 bit, 8 bit, 16 bit, 32 bit, and so on.

Electronic Design Automation (EDA) tool vendors as well as Silicon foundries provide optimized pre-defined layouts for standard logic gates (also known as standard cells) and pre-designed self-contained logic modules (also known as macro cells) in a given technology. Similarly, the present disclosure provides novel logic blocks at an abstraction that is higher than standard cells but lower than macro cells. These pre-configured logic primitives may be referred to as microcells or partial processing units. These microcells may be connected in various combinations and topologies to create useful arithmetic and logic modules like adders, shifters, multiplexers, comparators, etc., from which complete data-paths can be synthesized.

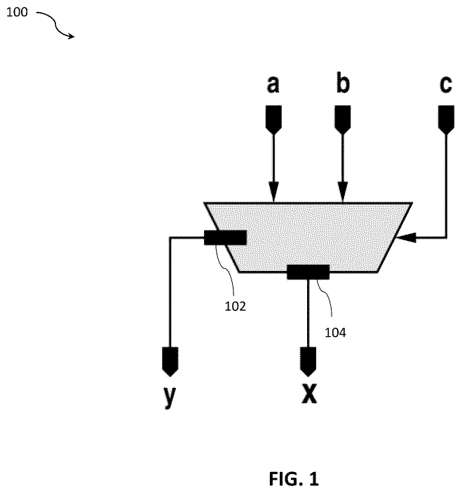

FIG. 1 illustrates a microcell of a microcell library, in accordance with an embodiment of the present disclosure. In an embodiment, a typical microcell 100 may implement a primitive logic (defined in detail below) and may have a uniform interface with three input operands a, b and c at an input interface and two output operands x and y at an output interface. In an embodiment, one or more of the three input operands and the two output operands may be enabled based on electric connection. Further, the two output operands x and y are latched to output registers 102 and 104 in a clock cycle.

In an embodiment, a library including a plurality of microcells 100 may be defined and hereinafter referred to as microcell library. The each microcell 100 of the microcell library may be defined to implement partial arithmetic, bitwise-logic, shift or control-flow operations operation based on one or more of the three input operands a, b and c to generate the two output operands x and y.

In an embodiment, the three input operands a, b and c_and each of the two output operands x and y may have a uniform pre-defined valency. In an embodiment, the uniform pre-defined valency may be selected from a pair (2-bits), a nibble (4-bits), a byte (8-bits), a half-word (16-bits), or an integer power of 2.

In an embodiment, the implementation of the logical operations or the partial arithmetic operations using one or more microcells from the library of microcells may be in a pipelined manner or an unpipelined manner.

In an embodiment, one or more of the plurality of microcells are combined for performing the partial arithmetic operation or the logical operation at a valency higher than the pre-defined valency.

In an embodiment, the microcell library may include, but not limited to, a logic microcell, a shift microcell, a mask microcell, a partial adder (padd) microcell, a partial subtractor (psub) microcell, a partial multiplier (pmlt) microcell, a compare microcell, a mux microcell, a demux microcell, etc.

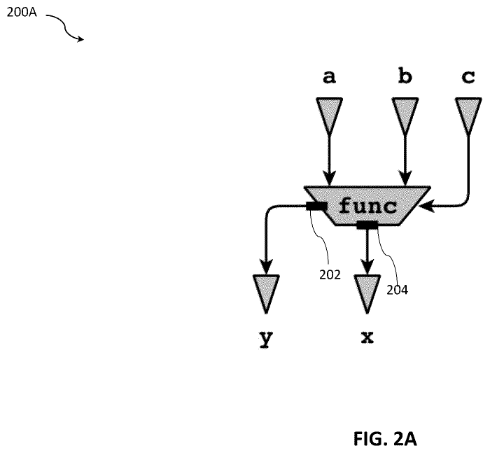

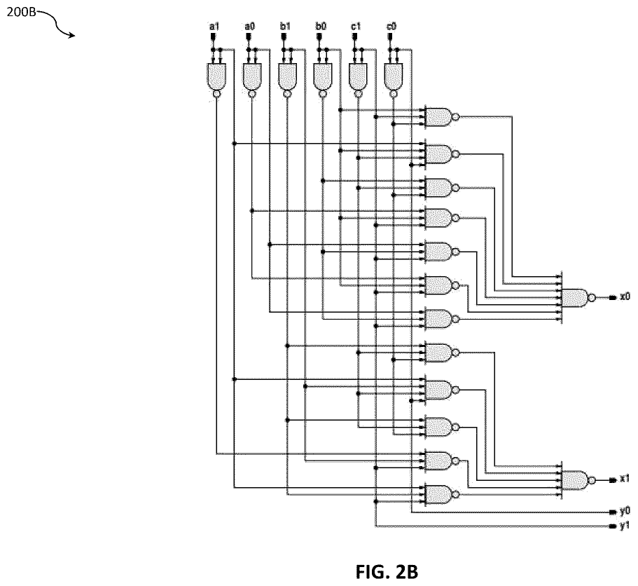

FIG. 2A illustrates a logic microcell of the microcell library, in accordance with an embodiment of the present disclosure. The logic microcell 200A may be configured to perform a bit-wise logic operation. In an embodiment, for performing the bit-wise logic operation, the logic microcell 200A may be configured to perform a bit-wise logic operation NOT on at least one of a first input operand a or other binary logic operations like AND, OR or Ex-OR on a first input operand a, a second input operand b based on a third input operand c to output a first output operand x of the two output operands x and y based on the bit-wise logic operation and a second output operand y of the two output operands x and y as a copy of the third input operand as the output y in the next clock cycle which are latched to a register 202. In an embodiment, the output x is also latched to a register 204.

In an embodiment, the logic microcell 200A may perform a bit-wise logic operation such as, but not limited to, a complement operation, AND operation, OR operation, EX-OR operation, etc.

In an embodiment, the logic microcell 200A may perform a complement operation by complementing one of the first input operand a, in case the third input operand c is Boolean value of 0. Further, the logic microcell 200A may perform an AND operation of the first input operand a and a second input operand b, in case the third input operand c is Boolean value of 1. Further, the logic microcell 200A may perform an OR operation of the first input operand a and a second input operand b, in case the third input operand c is Boolean value of 2. Further, the logic microcell 200A may perform an EX-OR operation of the first input operand a and a second input operand b, in case the third input operand c is Boolean value of 3.

FIG. 2B illustrates an exemplary implementation of a 2-bit logic microcell 200B using NAND gates, in accordance with an embodiment of the present disclosure.

In an embodiment, the three input operands a, b and c of the logic microcell 200B may be represented by the equations:

$$a = data\_in \_ 1 \qquad ( 1 )$$

$$b = data\_in \_ 0 \qquad ( 2 )$$

$$c = func \qquad ( 3 )$$

In an embodiment, data_in_0 represents the 2-bit input as first input operand and data_in_1 represents the 2-bit input as second input operand and func represents the 2-bit input as third input operand depicting the type of bit-wise operation to be performed on the input operands a and b.

In an embodiment, the logic microcell may implement bit-wise logical functions NOT, AND, OR and Ex-OR of the input pairs connected to a and b depending upon whether c is 00, 01, 10 or 11 respectively.

In an embodiment, the two output operands x and y of the logic microcell 200B may be connected as represented by the equations:

$$x = data\_out \_ 1 \qquad ( 4 )$$

$$y = func \qquad ( 5 )$$

The computation of x for a 2-bit logic micro-cell is based on the following logic:

$$if ( func = 0 ) , x = {( data\_in \_ 0 )}^{′} \qquad ( 6 )$$

$$else if ( func = 1 ) , x = data\_in \_ 1 \& data\_in \_ 0 \qquad ( 7 )$$

$$else if ( func = 2 ) , x = data\_in \_ 1 ‖ data\_in \_ 0 \qquad ( 8 )$$

$$else if ( func = 3 ) , x = data\_in \_ 1 ⊕ data\_in \_ 0 \qquad ( 9 )$$

FIG. 2B provides the implementation logic of the logic microcell 200B using NAND gates for 2-bit valency with a₁, a₀, b₁, b₀ and c₁, c₀ as respective inputs and x₁ x₀ and y₁ y₀ as the respective outputs as shown.

Table 1 below provides a truth table for the input a1, a0, b1, b0 and c1, c0 and corresponding outputs y1, y0 and x1, x0 for logic microcell.

TABLE 1

| a1 | a0 | b1 | b0 | c1 | c0 | y1 | y0 | x1 | x0 |
|---|---|---|---|---|---|---|---|---|---|
| 0 | 0 | 0 | 0 | 0 | 0 | 0 | 0 | 1 | 1 |
| 0 | 0 | 0 | 0 | 0 | 1 | 0 | 1 | 0 | 0 |
| 0 | 0 | 0 | 0 | 1 | 0 | 1 | 0 | 0 | 0 |
| 0 | 0 | 0 | 0 | 1 | 1 | 1 | 1 | 0 | 0 |
| 0 | 0 | 0 | 1 | 0 | 0 | 0 | 0 | 1 | 0 |
| 0 | 0 | 0 | 1 | 0 | 1 | 0 | 1 | 0 | 0 |
| 0 | 0 | 0 | 1 | 1 | 0 | 1 | 0 | 0 | 1 |
| 0 | 0 | 0 | 1 | 1 | 1 | 1 | 1 | 0 | 1 |
| 0 | 0 | 1 | 0 | 0 | 0 | 0 | 0 | 0 | 1 |
| 0 | 0 | 1 | 0 | 0 | 1 | 0 | 1 | 0 | 0 |
| 0 | 0 | 1 | 0 | 1 | 0 | 1 | 0 | 1 | 0 |
| 0 | 0 | 1 | 0 | 1 | 1 | 1 | 1 | 1 | 0 |
| 0 | 0 | 1 | 1 | 0 | 0 | 0 | 0 | 0 | 0 |
| 0 | 0 | 1 | 1 | 0 | 1 | 0 | 1 | 0 | 0 |
| 0 | 0 | 1 | 1 | 1 | 0 | 1 | 0 | 1 | 1 |
| 0 | 0 | 1 | 1 | 1 | 1 | 1 | 1 | 1 | 1 |
| 0 | 1 | 0 | 0 | 0 | 0 | 0 | 0 | 1 | 1 |
| 0 | 1 | 0 | 0 | 0 | 1 | 0 | 1 | 0 | 0 |
| 0 | 1 | 0 | 0 | 1 | 0 | 1 | 0 | 0 | 1 |
| 0 | 1 | 0 | 0 | 1 | 1 | 1 | 1 | 0 | 1 |
| 0 | 1 | 0 | 1 | 0 | 0 | 0 | 0 | 1 | 0 |
| 0 | 1 | 0 | 1 | 0 | 1 | 0 | 1 | 0 | 1 |
| 0 | 1 | 0 | 1 | 1 | 0 | 1 | 0 | 0 | 1 |
| 0 | 1 | 0 | 1 | 1 | 1 | 1 | 1 | 0 | 0 |
| 0 | 1 | 1 | 0 | 0 | 0 | 0 | 0 | 0 | 1 |
| 0 | 1 | 1 | 0 | 0 | 1 | 0 | 1 | 0 | 0 |
| 0 | 1 | 1 | 0 | 1 | 0 | 1 | 0 | 1 | 1 |
| 0 | 1 | 1 | 0 | 1 | 1 | 1 | 1 | 1 | 1 |
| 0 | 1 | 1 | 1 | 0 | 0 | 0 | 0 | 0 | 0 |
| 0 | 1 | 1 | 1 | 0 | 1 | 0 | 1 | 0 | 1 |
| 0 | 1 | 1 | 1 | 1 | 0 | 1 | 0 | 1 | 1 |
| 0 | 1 | 1 | 1 | 1 | 1 | 1 | 1 | 1 | 0 |
| 1 | 0 | 0 | 0 | 0 | 0 | 0 | 0 | 1 | 1 |
| 1 | 0 | 0 | 0 | 0 | 1 | 0 | 1 | 0 | 0 |
| 1 | 0 | 0 | 0 | 1 | 0 | 1 | 0 | 1 | 0 |
| 1 | 0 | 0 | 0 | 1 | 1 | 1 | 1 | 1 | 0 |
| 1 | 0 | 0 | 1 | 0 | 0 | 0 | 0 | 1 | 0 |
| 1 | 0 | 0 | 1 | 0 | 1 | 0 | 1 | 0 | 0 |
| 1 | 0 | 0 | 1 | 1 | 0 | 1 | 0 | 1 | 1 |
| 1 | 0 | 0 | 1 | 1 | 1 | 1 | 1 | 1 | 1 |
| 1 | 0 | 1 | 0 | 0 | 0 | 0 | 0 | 0 | 1 |
| 1 | 0 | 1 | 0 | 0 | 1 | 0 | 1 | 1 | 0 |
| 1 | 0 | 1 | 0 | 1 | 0 | 1 | 0 | 1 | 0 |
| 1 | 0 | 1 | 0 | 1 | 1 | 1 | 1 | 0 | 0 |
| 1 | 0 | 1 | 1 | 0 | 0 | 0 | 0 | 0 | 0 |
| 1 | 0 | 1 | 1 | 0 | 1 | 0 | 1 | 1 | 0 |
| 1 | 0 | 1 | 1 | 1 | 0 | 1 | 0 | 1 | 1 |
| 1 | 0 | 1 | 1 | 1 | 1 | 1 | 1 | 0 | 1 |
| 1 | 1 | 0 | 0 | 0 | 0 | 0 | 0 | 1 | 1 |
| 1 | 1 | 0 | 0 | 0 | 1 | 0 | 1 | 0 | 0 |
| 1 | 1 | 0 | 0 | 1 | 0 | 1 | 0 | 1 | 1 |
| 1 | 1 | 0 | 0 | 1 | 1 | 1 | 1 | 1 | 1 |
| 1 | 1 | 0 | 1 | 0 | 0 | 0 | 0 | 1 | 0 |
| 1 | 1 | 0 | 1 | 0 | 1 | 0 | 1 | 0 | 1 |
| 1 | 1 | 0 | 1 | 1 | 0 | 1 | 0 | 1 | 1 |
| 1 | 1 | 0 | 1 | 1 | 1 | 1 | 1 | 1 | 0 |
| 1 | 1 | 1 | 0 | 0 | 0 | 0 | 0 | 0 | 1 |
| 1 | 1 | 1 | 0 | 0 | 1 | 0 | 1 | 1 | 0 |
| 1 | 1 | 1 | 0 | 1 | 0 | 1 | 0 | 1 | 1 |
| 1 | 1 | 1 | 0 | 1 | 1 | 1 | 1 | 0 | 1 |
| 1 | 1 | 1 | 1 | 0 | 0 | 0 | 0 | 0 | 0 |
| 1 | 1 | 1 | 1 | 0 | 1 | 0 | 1 | 1 | 1 |
| 1 | 1 | 1 | 1 | 1 | 0 | 1 | 0 | 1 | 1 |
| 1 | 1 | 1 | 1 | 1 | 1 | 1 | 1 | 0 | 0 |

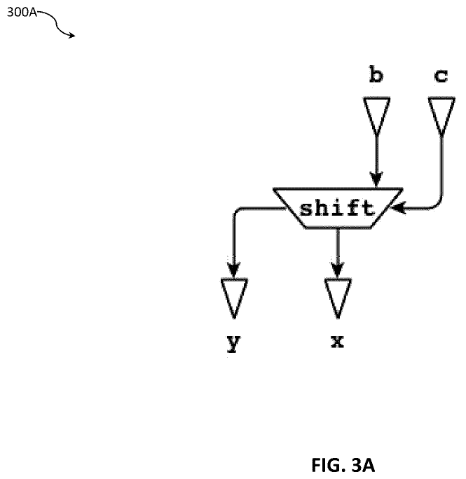

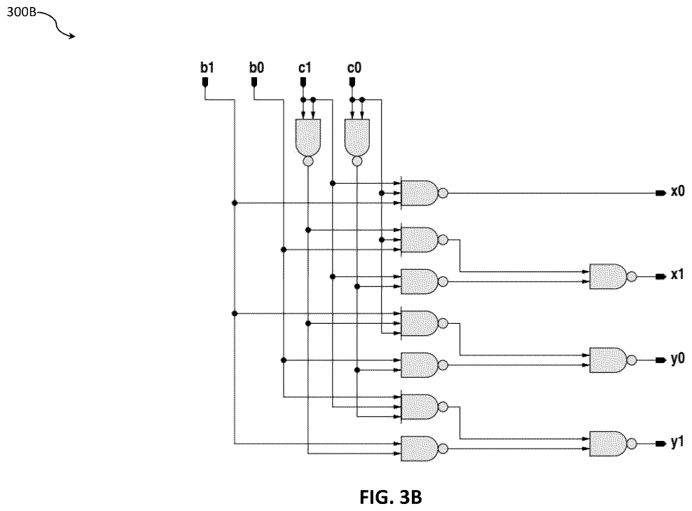

FIG. 3A illustrates a shift microcell 300A of the microcell library, in accordance with an exemplary embodiment. In an embodiment, the shift microcell 300A may be configured to perform a shift operation. For performing the shift operation, the shift microcell 300A may be configured to perform a bit-wise left shift operation on one of a second input operand b based on a number of bit-positions specified by the third input operand c from the three input operands a, b and c.

In an embodiment, the shift microcell 300A may perform a left shift operation only. In an embodiment, the first input operand a may be left unconnected while the second input operand b may be connected to the data to be shifted by a number of bit positions specified by the third input operand specified in 2's complement representation. The output x represents the lower half bits of the shifted input and the output y represents the upper half bits of the shifted input. In an embodiment, the lower half bits are padded with zeroes in the right bit positions and the upper half bits are padded with zeroes in the left bit positions.

FIG. 3B illustrates an exemplary implementation of a 2-bit shift microcell 300B using NAND gates, in accordance with an embodiment of the present disclosure.

In an embodiment, the input operand a may be unconnected or unutilized and the input, b and c and the output operands x and y of the shift microcell 300B may be connected as represented by the equations:

$$b = data\_in \qquad ( 10 )$$

$$c = shift amount in 2 ’ s complement \qquad ( 11 )$$

$$x = data\_out \_ 0 \qquad ( 12 )$$

$$y = data\_out \_ 1 \qquad ( 13 )$$

The computation of x and y for the 2-bit shift micro-cell is based on the following logic:

$$x = {( {b}_{10} ≪ c )}_{10} \qquad ( 14 )$$

$$y = {( {b}_{10} ≪ c )}_{32} \qquad ( 15 )$$

In an embodiment, the subscripts indicate the place values or the bit positions of the output.

Table 2 below provides a truth table for the input b1, b0 and c1, c0 and corresponding outputs y1, y0 and x1, x0 for left shift operation.

TABLE 2

| b1 | b0 | c1 | c0 | y1 | y0 | x1 | x0 |
|---|---|---|---|---|---|---|---|
| 0 | 0 | 0 | 0 | 0 | 0 | 0 | 0 |
| 0 | 0 | 0 | 1 | 0 | 0 | 0 | 0 |
| 0 | 0 | 1 | 0 | 0 | 0 | 0 | 0 |
| 0 | 0 | 1 | 1 | 0 | 0 | 0 | 0 |
| 0 | 1 | 0 | 0 | 0 | 0 | 0 | 1 |
| 0 | 1 | 0 | 1 | 0 | 0 | 1 | 0 |
| 0 | 1 | 1 | 0 | 0 | 1 | 0 | 0 |
| 0 | 1 | 1 | 1 | 1 | 0 | 0 | 0 |
| 1 | 0 | 0 | 0 | 0 | 0 | 1 | 0 |
| 1 | 0 | 0 | 1 | 0 | 1 | 0 | 0 |
| 1 | 0 | 1 | 0 | 1 | 0 | 0 | 0 |
| 1 | 0 | 1 | 1 | 0 | 0 | 0 | 0 |
| 1 | 1 | 0 | 0 | 0 | 0 | 1 | 1 |
| 1 | 1 | 0 | 1 | 0 | 1 | 1 | 0 |
| 1 | 1 | 1 | 0 | 1 | 1 | 0 | 0 |
| 1 | 1 | 1 | 1 | 1 | 0 | 0 | 0 |

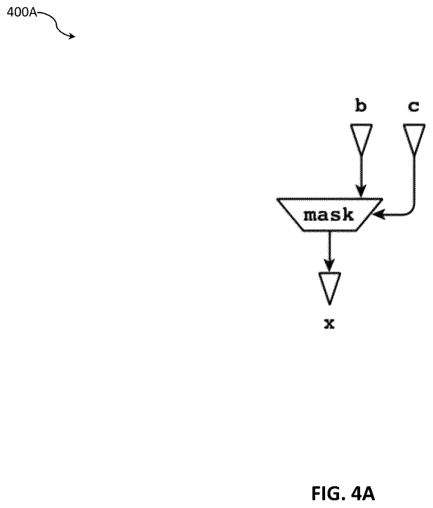

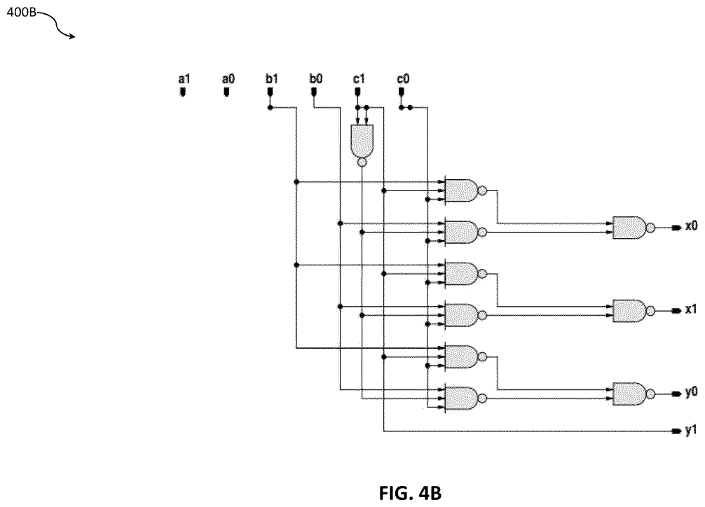

FIG. 4A illustrates a mask microcell 400A of the microcell library, in accordance with an embodiment of the present disclosure. In an embodiment, the mask microcell 400A may be configured for a mask operation. For performing the mask operation, the mask microcell 400A may be configured to output a corresponding place value of a first input operand a of the three input operands a, b and c as a first output operand x based on a place value specified by the second input operand b.

FIG. 4B illustrates an exemplary implementation of a 2-bit mask microcell 400B using NAND gates, in accordance with an embodiment of the present disclosure. The input a and the output y of the mask microcell 400B are left unconnected. The output x is the bit of the input b as indexed by the input c replicated at all bit positions. In an embodiment, the input operand a may be unconnected or unutilized and the input, b and c and the output operand x of the mask micro-cell 300B may be connected as represented by the equations:

$$b = data\_in \qquad ( 16 )$$

$$c = index\_position \qquad ( 17 )$$

$$x = data\_out \qquad ( 18 )$$

The computation of x for the 2-bit mask micro-cell is based on the following logic:

$$if ( c = 1 ) , x = ( b [ 1 ] , b [ 1 ] ) \qquad ( 19 )$$

$$else if ( c = 0 ) , x = ( b [ 0 ] , b [ 0 ] ) \qquad ( 20 )$$

Table 3 below provides a truth table for the input b1, b0 and c1, c0 and corresponding output x1, x0 for mask operation.

TABLE 3

| b1 | b0 | c1 | c0 | x1 | x0 |
|---|---|---|---|---|---|
| 0 | 0 | 0 | 0 | 0 | 0 |
| 0 | 0 | 0 | 1 | 0 | 0 |
| 0 | 1 | 0 | 0 | 1 | 1 |
| 0 | 1 | 0 | 1 | 0 | 0 |
| 1 | 0 | 0 | 0 | 0 | 0 |
| 1 | 0 | 0 | 1 | 1 | 1 |
| 1 | 1 | 0 | 0 | 1 | 1 |
| 1 | 1 | 0 | 1 | 1 | 1 |

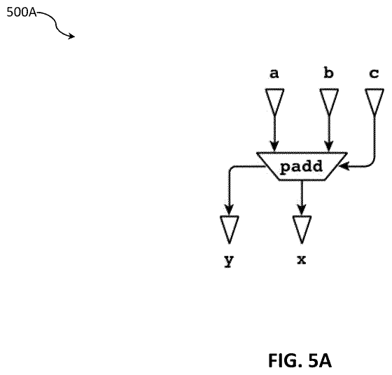

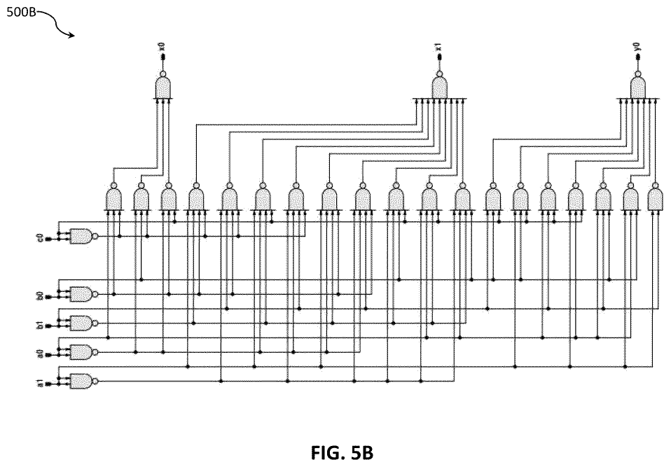

FIG. 5A illustrates a partial adder microcell 500A of the microcell library, in accordance with an embodiment of the present disclosure. In an embodiment, the partial adder microcell 500A may be configured to perform a partial addition operation to output the sum of the three input operands a, b and c as the two output operands x and y, wherein the first output operand x may represent the sum output, and the second output operand y may represent the carryout of the sum. In an embodiment, the three input ports of the three input operands a, b and c and the two output ports of the two output operands x and y are connected as:

$$c = {carry}_{in} \qquad ( 21 )$$

$$b = augend \qquad ( 22 )$$

$$a = addend \qquad ( 23 )$$

$$x = sum \qquad ( 24 )$$

$$y = {carry}_{out} \qquad ( 25 )$$

FIG. 5B illustrates an exemplary implementation of a 2-bit partial adder microcell using NAND gates, in accordance with an embodiment of the present disclosure. In an embodiment, the functional semantics of the 2-bit partial adder micro-cell may be represented by the equations:

$$x = {( a + b + c )}_{10} \qquad ( 26 )$$

$${y}_{0} = {( a + b + c )}_{2} \qquad ( 27 )$$

Table 4 below provides a truth table for the input a1, a0, b1, b0 and c0 and corresponding output x1, x0 and y0 for padd operation.

TABLE 4

| a1 | a0 | b1 | b0 | c0 | y0 | x1 | x0 |
|---|---|---|---|---|---|---|---|
| 0 | 0 | 0 | 0 | 0 | 0 | 0 | 0 |
| 0 | 0 | 0 | 0 | 1 | 0 | 0 | 1 |
| 0 | 0 | 0 | 1 | 0 | 0 | 0 | 1 |
| 0 | 0 | 0 | 1 | 1 | 0 | 1 | 0 |
| 0 | 0 | 1 | 0 | 0 | 0 | 1 | 0 |
| 0 | 0 | 1 | 0 | 1 | 0 | 1 | 1 |
| 0 | 0 | 1 | 1 | 0 | 0 | 1 | 1 |
| 0 | 0 | 1 | 1 | 1 | 1 | 0 | 0 |
| 0 | 1 | 0 | 0 | 0 | 0 | 0 | 1 |
| 0 | 1 | 0 | 0 | 1 | 0 | 1 | 0 |
| 0 | 1 | 0 | 1 | 0 | 0 | 1 | 0 |
| 0 | 1 | 0 | 1 | 1 | 0 | 1 | 1 |
| 0 | 1 | 1 | 0 | 0 | 0 | 1 | 1 |
| 0 | 1 | 1 | 0 | 1 | 1 | 0 | 0 |
| 0 | 1 | 1 | 1 | 0 | 1 | 0 | 0 |
| 0 | 1 | 1 | 1 | 1 | 1 | 0 | 1 |
| 1 | 0 | 0 | 0 | 0 | 0 | 1 | 0 |
| 1 | 0 | 0 | 0 | 1 | 0 | 1 | 1 |
| 1 | 0 | 0 | 1 | 0 | 0 | 1 | 1 |
| 1 | 0 | 0 | 1 | 1 | 1 | 0 | 0 |
| 1 | 0 | 1 | 0 | 0 | 1 | 0 | 0 |
| 1 | 0 | 1 | 0 | 1 | 1 | 0 | 1 |
| 1 | 0 | 1 | 1 | 0 | 1 | 0 | 1 |
| 1 | 0 | 1 | 1 | 1 | 1 | 1 | 0 |
| 1 | 1 | 0 | 0 | 0 | 0 | 1 | 1 |
| 1 | 1 | 0 | 0 | 1 | 1 | 0 | 0 |
| 1 | 1 | 0 | 1 | 0 | 1 | 0 | 0 |
| 1 | 1 | 0 | 1 | 1 | 1 | 0 | 1 |
| 1 | 1 | 1 | 0 | 0 | 1 | 0 | 1 |
| 1 | 1 | 1 | 0 | 1 | 1 | 1 | 0 |
| 1 | 1 | 1 | 1 | 0 | 1 | 1 | 0 |
| 1 | 1 | 1 | 1 | 1 | 1 | 1 | 1 |

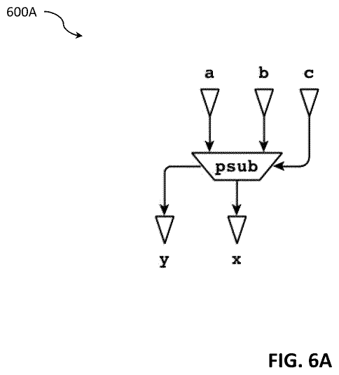

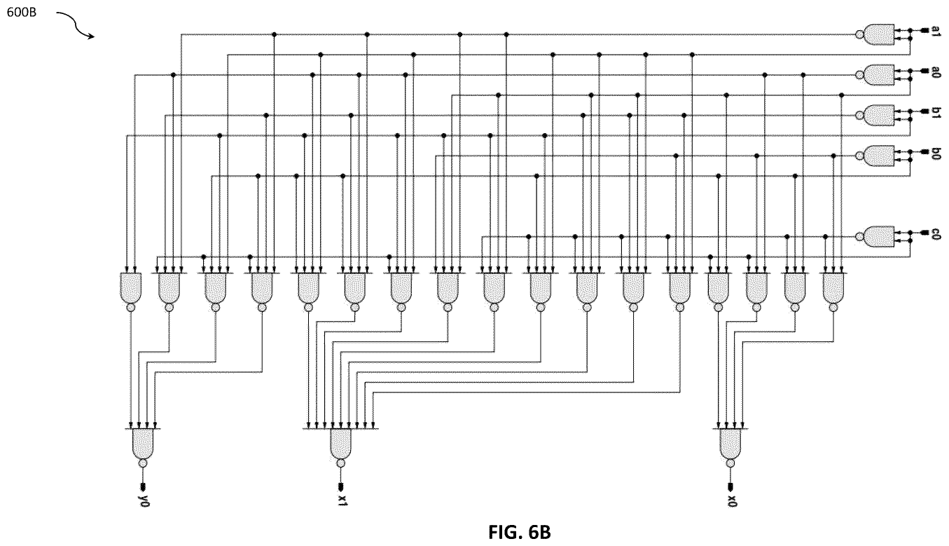

FIG. 6A illustrates a partial subtractor microcell 600A of the microcell library, in accordance with an embodiment of the present disclosure. In an embodiment, the partial subtractor microcell 600A may be configured to perform a partial subtraction operation to output the difference by subtracting a second input operand b and a third input operand c from a first input operand a, wherein a first output operand x may represent the difference output in 2's compliment form, and the second output operand y may represent the borrowₒᵤₜ of the difference output. In an embodiment, the three input ports of the three input operands a, b and c and the two output ports of the two output operands x and y are connected as:

$$c = {borrow}_{in} \qquad ( 28 )$$

$$b = subtrahend \qquad ( 29 )$$

$$a = minuend \qquad ( 30 )$$

$$x = difference \qquad ( 31 )$$

$$y = {borrow}_{out} \qquad ( 32 )$$

FIG. 6B illustrates an exemplary implementation of a 2-bit partial subtractor microcell using NAND gates, in accordance with an embodiment of the present disclosure. In an embodiment, the functional semantics of the 2-bit partial subtractor microcell may be represented by the equations:

$$x = {( a - b - c )}_{10} \qquad ( 33 )$$

$${y}_{0} = {( a - b - c )}_{2} \qquad ( 34 )$$

Table 5 below provides a truth table for the input a1, a0, b1, b0 and c0 and corresponding output x1, x0 and v0 for psub operation.

TABLE 5

| a1 | a0 | b1 | b0 | c0 | y0 | x1 | x0 |
|---|---|---|---|---|---|---|---|
| 0 | 0 | 0 | 0 | 0 | 0 | 0 | 0 |
| 0 | 0 | 0 | 0 | 1 | 1 | 1 | 1 |
| 0 | 0 | 0 | 1 | 0 | 1 | 1 | 0 |
| 0 | 0 | 0 | 1 | 1 | 1 | 1 | 0 |
| 0 | 0 | 1 | 0 | 0 | 1 | 1 | 0 |
| 0 | 0 | 1 | 0 | 1 | 1 | 0 | 1 |
| 0 | 0 | 1 | 1 | 0 | 1 | 0 | 1 |
| 0 | 0 | 1 | 1 | 1 | 1 | 0 | 0 |
| 0 | 1 | 0 | 0 | 0 | 0 | 0 | 1 |
| 0 | 1 | 0 | 0 | 1 | 0 | 0 | 0 |
| 0 | 1 | 0 | 1 | 0 | 0 | 0 | 0 |
| 0 | 1 | 0 | 1 | 1 | 1 | 1 | 1 |
| 0 | 1 | 1 | 0 | 0 | 1 | 1 | 1 |
| 0 | 1 | 1 | 0 | 1 | 1 | 1 | 0 |
| 0 | 1 | 1 | 1 | 0 | 1 | 1 | 0 |
| 0 | 1 | 1 | 1 | 1 | 1 | 0 | 1 |
| 1 | 0 | 0 | 0 | 0 | 0 | 1 | 0 |
| 1 | 0 | 0 | 0 | 1 | 0 | 0 | 1 |
| 1 | 0 | 0 | 1 | 0 | 0 | 0 | 1 |
| 1 | 0 | 0 | 1 | 1 | 0 | 0 | 0 |
| 1 | 0 | 1 | 0 | 0 | 0 | 0 | 0 |
| 1 | 0 | 1 | 0 | 1 | 1 | 1 | 1 |
| 1 | 0 | 1 | 1 | 0 | 1 | 1 | 1 |
| 1 | 0 | 1 | 1 | 1 | 1 | 1 | 0 |
| 1 | 1 | 0 | 0 | 0 | 0 | 1 | 1 |
| 1 | 1 | 0 | 0 | 1 | 0 | 1 | 0 |
| 1 | 1 | 0 | 1 | 0 | 0 | 1 | 0 |
| 1 | 1 | 0 | 1 | 1 | 0 | 0 | 1 |
| 1 | 1 | 1 | 0 | 0 | 0 | 0 | 1 |
| 1 | 1 | 1 | 0 | 1 | 0 | 0 | 0 |
| 1 | 1 | 1 | 1 | 0 | 0 | 0 | 0 |
| 1 | 1 | 1 | 1 | 1 | 1 | 1 | 1 |

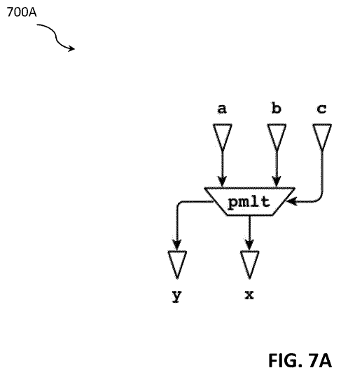

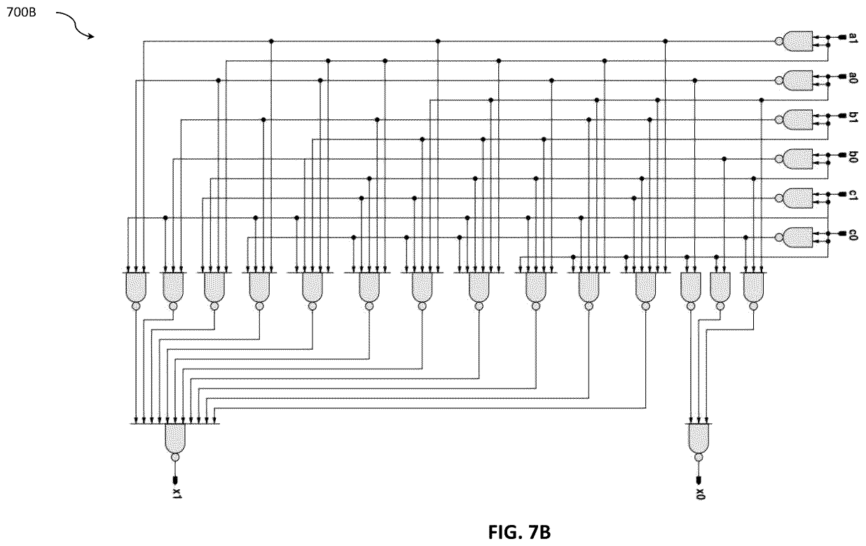

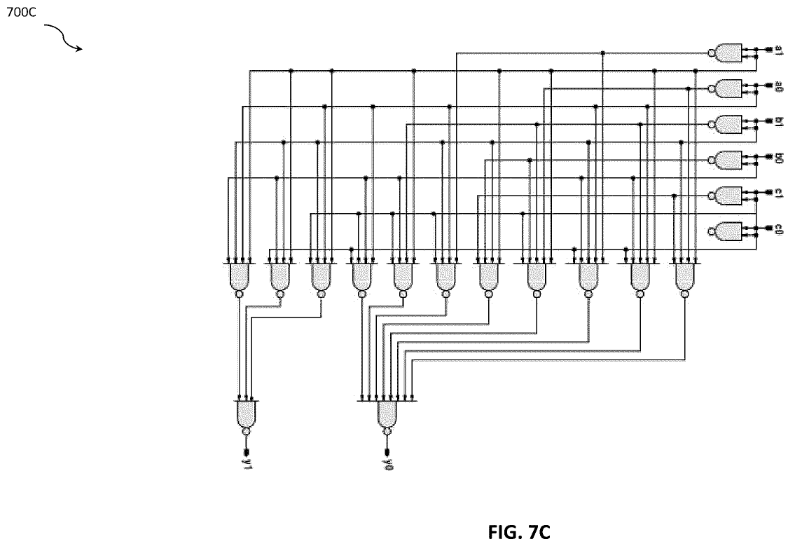

FIG. 7A illustrates a partial multiply-add microcell of the microcell library, in accordance with an embodiment of the present disclosure. In an embodiment, the partial multiply-add microcell 700A may be configured to perform a partial multiplyadd operation to output a product of a first input operand a and a second input operand b added to a third input operand c. In an embodiment, a first output operand x may represent a lower half significant bit of the output, and a second output operand y may represent an upper half significant bits of the output. In an embodiment, the three input ports of the three input operands a, b and c and the two output ports of the two output operands x and y are connected as:

$$c = augend \qquad ( 35 )$$

$$b = multiplier \qquad ( 36 )$$

$$a = multiplicand \qquad ( 37 )$$

$$x = {product}_{low} \qquad ( 38 )$$

$$y = {product}_{high} \qquad ( 39 )$$

FIG. 7B and FIG. 7C illustrates an exemplary implementation of a 2-bit partial multiplier microcell using NAND gates, in accordance with an embodiment of the present disclosure. In an embodiment, the functional semantics of the 2-bit partial multiplier microcell may be represented by the equations:

$$x = {( a * b + c )}_{10} \qquad ( 40 )$$

$$y = {( a * b + c )}_{32} \qquad ( 41 )$$

Table 6 below provides a truth table for the input a1, a0, b1, b0, c1, and c0 and corresponding output x1, x0, y1, and y0 for partial multiplier operation.

TABLE 6

| a1 | a0 | b1 | b0 | c1 | c0 | y1 | y0 | x1 | x0 |
|---|---|---|---|---|---|---|---|---|---|
| 0 | 0 | 0 | 0 | 0 | 0 | 0 | 0 | 0 | 0 |
| 0 | 0 | 0 | 0 | 0 | 1 | 0 | 0 | 0 | 1 |
| 0 | 0 | 0 | 0 | 1 | 0 | 0 | 0 | 1 | 0 |
| 0 | 0 | 0 | 0 | 1 | 1 | 0 | 0 | 1 | 1 |
| 0 | 0 | 0 | 1 | 0 | 0 | 0 | 0 | 0 | 0 |
| 0 | 0 | 0 | 1 | 0 | 1 | 0 | 0 | 0 | 1 |
| 0 | 0 | 0 | 1 | 1 | 0 | 0 | 0 | 1 | 0 |
| 0 | 0 | 0 | 1 | 1 | 1 | 0 | 0 | 1 | 1 |
| 0 | 0 | 1 | 0 | 0 | 0 | 0 | 0 | 0 | 0 |
| 0 | 0 | 1 | 0 | 0 | 1 | 0 | 0 | 0 | 1 |
| 0 | 0 | 1 | 0 | 1 | 0 | 0 | 0 | 1 | 0 |
| 0 | 0 | 1 | 0 | 1 | 1 | 0 | 0 | 1 | 1 |
| 0 | 0 | 1 | 1 | 0 | 0 | 0 | 0 | 0 | 0 |
| 0 | 0 | 1 | 1 | 0 | 1 | 0 | 0 | 0 | 1 |
| 0 | 0 | 1 | 1 | 1 | 0 | 0 | 0 | 1 | 0 |
| 0 | 0 | 1 | 1 | 1 | 1 | 0 | 0 | 1 | 1 |
| 0 | 1 | 0 | 0 | 0 | 0 | 0 | 0 | 0 | 0 |
| 0 | 1 | 0 | 0 | 0 | 1 | 0 | 0 | 0 | 1 |
| 0 | 1 | 0 | 0 | 1 | 0 | 0 | 0 | 1 | 0 |
| 0 | 1 | 0 | 0 | 1 | 1 | 0 | 0 | 1 | 1 |
| 0 | 1 | 0 | 1 | 0 | 0 | 0 | 0 | 0 | 1 |
| 0 | 1 | 0 | 1 | 0 | 1 | 0 | 0 | 1 | 0 |
| 0 | 1 | 0 | 1 | 1 | 0 | 0 | 0 | 1 | 1 |
| 0 | 1 | 0 | 1 | 1 | 1 | 0 | 1 | 0 | 0 |
| 0 | 1 | 1 | 0 | 0 | 0 | 0 | 0 | 1 | 0 |
| 0 | 1 | 1 | 0 | 0 | 1 | 0 | 0 | 1 | 1 |
| 0 | 1 | 1 | 0 | 1 | 0 | 0 | 1 | 0 | 0 |
| 0 | 1 | 1 | 0 | 1 | 1 | 0 | 1 | 0 | 1 |
| 0 | 1 | 1 | 1 | 0 | 0 | 0 | 0 | 1 | 1 |
| 0 | 1 | 1 | 1 | 0 | 1 | 0 | 1 | 0 | 0 |
| 0 | 1 | 1 | 1 | 1 | 0 | 0 | 1 | 0 | 1 |
| 0 | 1 | 1 | 1 | 1 | 1 | 0 | 1 | 1 | 0 |
| 1 | 0 | 0 | 0 | 0 | 0 | 0 | 0 | 0 | 0 |
| 1 | 0 | 0 | 0 | 0 | 1 | 0 | 0 | 0 | 1 |
| 1 | 0 | 0 | 0 | 1 | 0 | 0 | 0 | 1 | 0 |
| 1 | 0 | 0 | 0 | 1 | 1 | 0 | 0 | 1 | 1 |
| 1 | 0 | 0 | 1 | 0 | 0 | 0 | 0 | 1 | 0 |
| 1 | 0 | 0 | 1 | 0 | 1 | 0 | 0 | 1 | 1 |
| 1 | 0 | 0 | 1 | 1 | 0 | 0 | 1 | 0 | 0 |
| 1 | 0 | 0 | 1 | 1 | 1 | 0 | 1 | 0 | 1 |
| 1 | 0 | 1 | 0 | 0 | 0 | 0 | 1 | 0 | 0 |
| 1 | 0 | 1 | 0 | 0 | 1 | 0 | 1 | 0 | 1 |
| 1 | 0 | 1 | 0 | 1 | 0 | 0 | 1 | 1 | 0 |
| 1 | 0 | 1 | 0 | 1 | 1 | 0 | 1 | 1 | 1 |
| 1 | 0 | 1 | 1 | 0 | 0 | 0 | 1 | 1 | 0 |
| 1 | 0 | 1 | 1 | 0 | 1 | 0 | 1 | 1 | 1 |
| 1 | 0 | 1 | 1 | 1 | 0 | 1 | 0 | 0 | 0 |
| 1 | 0 | 1 | 1 | 1 | 1 | 1 | 0 | 0 | 1 |
| 1 | 1 | 0 | 0 | 0 | 0 | 0 | 0 | 0 | 0 |
| 1 | 1 | 0 | 0 | 0 | 1 | 0 | 0 | 0 | 1 |
| 1 | 1 | 0 | 0 | 1 | 0 | 0 | 0 | 1 | 0 |
| 1 | 1 | 0 | 0 | 1 | 1 | 0 | 0 | 1 | 1 |
| 1 | 1 | 0 | 1 | 0 | 0 | 0 | 0 | 1 | 1 |
| 1 | 1 | 0 | 1 | 0 | 1 | 0 | 1 | 0 | 0 |
| 1 | 1 | 0 | 1 | 1 | 0 | 0 | 1 | 0 | 1 |
| 1 | 1 | 0 | 1 | 1 | 1 | 0 | 1 | 1 | 0 |
| 1 | 1 | 1 | 0 | 0 | 0 | 0 | 1 | 1 | 0 |
| 1 | 1 | 1 | 0 | 0 | 1 | 0 | 1 | 1 | 1 |
| 1 | 1 | 1 | 0 | 1 | 0 | 1 | 0 | 0 | 0 |
| 1 | 1 | 1 | 0 | 1 | 1 | 1 | 0 | 0 | 1 |
| 1 | 1 | 1 | 1 | 0 | 0 | 1 | 0 | 0 | 1 |
| 1 | 1 | 1 | 1 | 0 | 1 | 1 | 0 | 1 | 0 |
| 1 | 1 | 1 | 1 | 1 | 0 | 1 | 0 | 1 | 1 |
| 1 | 1 | 1 | 1 | 1 | 1 | 1 | 1 | 0 | 0 |

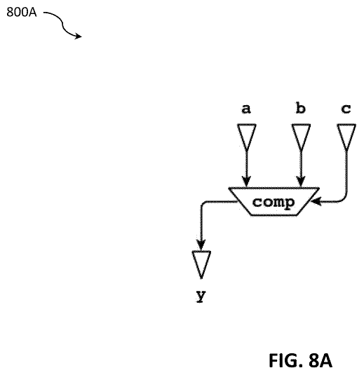

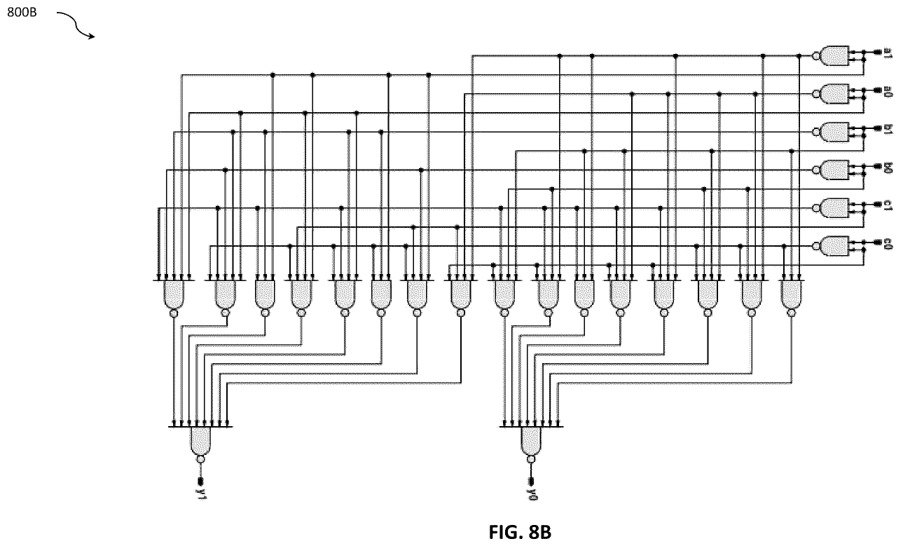

FIG. 8A illustrates a compare microcell 800A of the microcell library, in accordance with an embodiment of the present disclosure. The output x of the compare microcell 800A is left unconnected. In an embodiment, the compare microcell 800A may be configured to perform a compare operation to output a second output operand y as “0” in case a first input operand a is equal to a second input operand b and in case a third input operand c is equal to “0”. In an embodiment, the compare microcell 800A may be configured to output the second output operand y as “1” in case the first input operand a is greater than the second input operand b or in case the first input operand a is equal to the second input operand b and the third input operand c is equal to “1”. In an embodiment, the compare microcell 800A may be configured to output the second output operand y as “2” in case the first input operand a is less than the second input operand b or in case the first input operand a is equal to the second input operand b and the third input operand c is equal to “2”. In an embodiment, the three input ports of the three input operands a, b and c and one output port y are connected as:

$$c = compare\_so \_far \qquad ( 42 )$$

$$b = data\_in \_ 0 \qquad ( 43 )$$

$$a = data\_in \_ 1 \qquad ( 44 )$$

$$y = {comparison}_{out} \qquad ( 45 )$$

FIG. 8B illustrates an exemplary implementation of a 2-bit compare microcell 800B using NAND gates, in accordance with an embodiment of the present disclosure. The computation of y for 2-bit input of a, b and c is based on functional semantic represented by the following logic:

$$if ( b = a \& c = 0 ) , y = 0 \qquad ( 46 )$$

$$else if ( b > a \vert b = a \& c = 1 ) , y = 1 \qquad ( 47 )$$

$$else if ( b < a \vert b = a \& c = 2 ) , y = 2 \qquad ( 48 )$$

Table 7 below provides a truth table for the input a1, a0, b1, b0, c1, and c0 and corresponding output x1, x0, y1, and y0 for compare operation.

TABLE 7

| a1 | a0 | b1 | b0 | c1 | c0 | y1 | y0 | x1 | x0 |
|---|---|---|---|---|---|---|---|---|---|
| 0 | 0 | 0 | 0 | 0 | 0 | 0 | 0 | 0 | 0 |
| 0 | 0 | 0 | 0 | 0 | 1 | 0 | 1 | 0 | 1 |
| 0 | 0 | 0 | 0 | 1 | 0 | 1 | 0 | 1 | 0 |
| 0 | 0 | 0 | 0 | 1 | 1 | 1 | 1 | 0 | 0 |
| 0 | 0 | 0 | 1 | 0 | 0 | 0 | 0 | 0 | 1 |
| 0 | 0 | 0 | 1 | 0 | 1 | 0 | 1 | 0 | 1 |
| 0 | 0 | 0 | 1 | 1 | 0 | 1 | 0 | 0 | 1 |
| 0 | 0 | 0 | 1 | 1 | 1 | 1 | 1 | 0 | 1 |
| 0 | 0 | 1 | 0 | 0 | 0 | 0 | 0 | 0 | 1 |
| 0 | 0 | 1 | 0 | 0 | 1 | 0 | 1 | 0 | 1 |
| 0 | 0 | 1 | 0 | 1 | 0 | 1 | 0 | 0 | 1 |
| 0 | 0 | 1 | 0 | 1 | 1 | 1 | 1 | 0 | 1 |
| 0 | 0 | 1 | 1 | 0 | 0 | 0 | 0 | 0 | 1 |
| 0 | 0 | 1 | 1 | 0 | 1 | 0 | 1 | 0 | 1 |
| 0 | 0 | 1 | 1 | 1 | 0 | 1 | 0 | 0 | 1 |
| 0 | 0 | 1 | 1 | 1 | 1 | 1 | 1 | 0 | 1 |
| 0 | 1 | 0 | 0 | 0 | 0 | 0 | 0 | 1 | 0 |
| 0 | 1 | 0 | 0 | 0 | 1 | 0 | 1 | 1 | 0 |
| 0 | 1 | 0 | 0 | 1 | 0 | 1 | 0 | 1 | 0 |
| 0 | 1 | 0 | 0 | 1 | 1 | 1 | 1 | 1 | 0 |
| 0 | 1 | 0 | 1 | 0 | 0 | 0 | 0 | 0 | 0 |
| 0 | 1 | 0 | 1 | 0 | 1 | 0 | 1 | 0 | 1 |
| 0 | 1 | 0 | 1 | 1 | 0 | 1 | 0 | 1 | 0 |
| 0 | 1 | 0 | 1 | 1 | 1 | 1 | 1 | 0 | 0 |
| 0 | 1 | 1 | 0 | 0 | 0 | 0 | 0 | 0 | 1 |
| 0 | 1 | 1 | 0 | 0 | 1 | 0 | 1 | 0 | 1 |
| 0 | 1 | 1 | 0 | 1 | 0 | 1 | 0 | 0 | 1 |
| 0 | 1 | 1 | 0 | 1 | 1 | 1 | 1 | 0 | 1 |
| 0 | 1 | 1 | 1 | 0 | 0 | 0 | 0 | 0 | 1 |
| 0 | 1 | 1 | 1 | 0 | 1 | 0 | 1 | 0 | 1 |
| 0 | 1 | 1 | 1 | 1 | 0 | 1 | 0 | 0 | 1 |
| 0 | 1 | 1 | 1 | 1 | 1 | 1 | 1 | 0 | 1 |
| 1 | 0 | 0 | 0 | 0 | 0 | 0 | 0 | 1 | 0 |
| 1 | 0 | 0 | 0 | 0 | 1 | 0 | 1 | 1 | 0 |
| 1 | 0 | 0 | 0 | 1 | 0 | 1 | 0 | 1 | 0 |
| 1 | 0 | 0 | 0 | 1 | 1 | 1 | 1 | 1 | 0 |
| 1 | 0 | 0 | 1 | 0 | 0 | 0 | 0 | 1 | 0 |
| 1 | 0 | 0 | 1 | 0 | 1 | 0 | 1 | 1 | 0 |
| 1 | 0 | 0 | 1 | 1 | 0 | 1 | 0 | 1 | 0 |
| 1 | 0 | 0 | 1 | 1 | 1 | 1 | 1 | 1 | 0 |
| 1 | 0 | 1 | 0 | 0 | 0 | 0 | 0 | 0 | 0 |
| 1 | 0 | 1 | 0 | 0 | 1 | 0 | 1 | 0 | 1 |
| 1 | 0 | 1 | 0 | 1 | 0 | 1 | 0 | 1 | 0 |
| 1 | 0 | 1 | 0 | 1 | 1 | 1 | 1 | 0 | 0 |
| 1 | 0 | 1 | 1 | 0 | 0 | 0 | 0 | 0 | 1 |
| 1 | 0 | 1 | 1 | 0 | 1 | 0 | 1 | 0 | 1 |
| 1 | 0 | 1 | 1 | 1 | 0 | 1 | 0 | 0 | 1 |
| 1 | 0 | 1 | 1 | 1 | 1 | 1 | 1 | 0 | 1 |
| 1 | 1 | 0 | 0 | 0 | 0 | 0 | 0 | 1 | 0 |
| 1 | 1 | 0 | 0 | 0 | 1 | 0 | 1 | 1 | 0 |
| 1 | 1 | 0 | 0 | 1 | 0 | 1 | 0 | 1 | 0 |
| 1 | 1 | 0 | 0 | 1 | 1 | 1 | 1 | 1 | 0 |
| 1 | 1 | 0 | 1 | 0 | 0 | 0 | 0 | 1 | 0 |
| 1 | 1 | 0 | 1 | 0 | 1 | 0 | 1 | 1 | 0 |
| 1 | 1 | 0 | 1 | 1 | 0 | 1 | 0 | 1 | 0 |
| 1 | 1 | 0 | 1 | 1 | 1 | 1 | 1 | 1 | 0 |
| 1 | 1 | 1 | 0 | 0 | 0 | 0 | 0 | 1 | 0 |
| 1 | 1 | 1 | 0 | 0 | 1 | 0 | 1 | 1 | 0 |
| 1 | 1 | 1 | 0 | 1 | 0 | 1 | 0 | 1 | 0 |
| 1 | 1 | 1 | 0 | 1 | 1 | 1 | 1 | 1 | 0 |
| 1 | 1 | 1 | 1 | 0 | 0 | 0 | 0 | 0 | 0 |
| 1 | 1 | 1 | 1 | 0 | 1 | 0 | 1 | 0 | 1 |
| 1 | 1 | 1 | 1 | 1 | 0 | 1 | 0 | 1 | 0 |
| 1 | 1 | 1 | 1 | 1 | 1 | 1 | 1 | 0 | 0 |

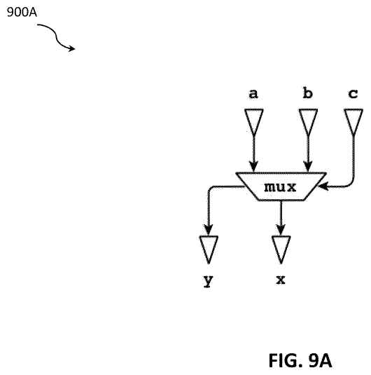

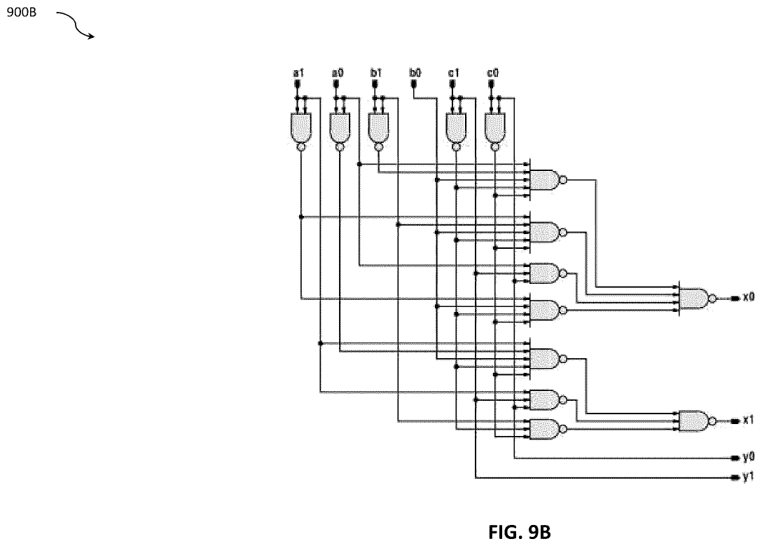

FIG. 9A illustrates a mux microcell 900A of the microcell library, in accordance with an embodiment of the present disclosure. In an embodiment, the mux microcell 900A may be configured to perform a multiplexing operation to select at first output operand x equal to a first input operand a from the three input operands a, b and c in case the third input operand c is equal to “0”. In an embodiment, the mux microcell 900A may be configured to perform a multiplexing operation to select at first output operand x equal to a second input operand b from the three input operands a, b and c in case the third input operand c is equal to “3”. In an embodiment, the mux microcell 900A may be configured to replicate a third input operand c from the three input operands a, b and c at the second output operand y. In an embodiment, the three input ports of the three input operands a, b and c and the two output ports x and y are connected as:

$$c = select \qquad ( 49 )$$

$$b = data\_in \_ 0 \qquad ( 50 )$$

$$a = data\_in \_ 1 \qquad ( 51 )$$

$$x = data\_out \qquad ( 52 )$$

$$y = select \qquad ( 53 )$$

FIG. 9B illustrates an exemplary implementation of a 2-bit mux microcell using NAND gates, in accordance with an embodiment of the present disclosure. In an embodiment, the functional semantics of the 2-bit mux microcell 900B may be represented by the following logic:

$$if ( c = 0 ) , x = b \qquad ( 54 )$$

$$else if ( c = 3 ) , x = a \qquad ( 55 )$$

$$y = c \qquad ( 56 )$$

Table 8 below provides a truth table for the input a1, a0, b1, b0, c1, and c0 and corresponding output x1, x0, y1, and y0 for mux operation.

TABLE 8

| a1 | a0 | b1 | b0 | c1 | c0 | y1 | y0 | x1 | x0 |
|---|---|---|---|---|---|---|---|---|---|
| 0 | 0 | 0 | 0 | 0 | 0 | 0 | 0 | 0 | 0 |
| 0 | 0 | 0 | 0 | 1 | 1 | 1 | 1 | 0 | 0 |
| 0 | 0 | 0 | 1 | 0 | 0 | 0 | 0 | 0 | 1 |
| 0 | 0 | 0 | 1 | 1 | 1 | 1 | 1 | 0 | 0 |
| 0 | 0 | 1 | 0 | 0 | 0 | 0 | 0 | 1 | 0 |
| 0 | 0 | 1 | 0 | 1 | 1 | 1 | 1 | 0 | 0 |
| 0 | 0 | 1 | 1 | 0 | 0 | 0 | 0 | 1 | 1 |
| 0 | 0 | 1 | 1 | 1 | 1 | 1 | 1 | 0 | 0 |
| 0 | 1 | 0 | 0 | 0 | 0 | 0 | 0 | 0 | 0 |
| 0 | 1 | 0 | 0 | 1 | 1 | 1 | 1 | 0 | 1 |
| 0 | 1 | 0 | 1 | 0 | 0 | 0 | 0 | 0 | 1 |
| 0 | 1 | 0 | 1 | 1 | 1 | 1 | 1 | 0 | 1 |
| 0 | 1 | 1 | 0 | 0 | 0 | 0 | 0 | 1 | 0 |
| 0 | 1 | 1 | 0 | 1 | 1 | 1 | 1 | 0 | 1 |
| 0 | 1 | 1 | 1 | 0 | 0 | 0 | 0 | 1 | 1 |
| 0 | 1 | 1 | 1 | 1 | 1 | 1 | 1 | 0 | 1 |
| 1 | 0 | 0 | 0 | 0 | 0 | 0 | 0 | 0 | 0 |
| 1 | 0 | 0 | 0 | 1 | 1 | 1 | 1 | 1 | 0 |
| 1 | 0 | 0 | 1 | 0 | 0 | 0 | 0 | 0 | 1 |
| 1 | 0 | 0 | 1 | 1 | 1 | 1 | 1 | 1 | 0 |
| 1 | 0 | 1 | 0 | 0 | 0 | 0 | 0 | 1 | 0 |
| 1 | 0 | 1 | 0 | 1 | 1 | 1 | 1 | 1 | 0 |
| 1 | 0 | 1 | 1 | 0 | 0 | 0 | 0 | 1 | 1 |
| 1 | 0 | 1 | 1 | 1 | 1 | 1 | 1 | 1 | 0 |
| 1 | 1 | 0 | 0 | 0 | 0 | 0 | 0 | 0 | 0 |
| 1 | 1 | 0 | 0 | 1 | 1 | 1 | 1 | 1 | 1 |
| 1 | 1 | 0 | 1 | 0 | 0 | 0 | 0 | 0 | 1 |
| 1 | 1 | 0 | 1 | 1 | 1 | 1 | 1 | 1 | 1 |
| 1 | 1 | 1 | 0 | 0 | 0 | 0 | 0 | 1 | 0 |
| 1 | 1 | 1 | 0 | 1 | 1 | 1 | 1 | 1 | 1 |
| 1 | 1 | 1 | 1 | 0 | 0 | 0 | 0 | 1 | 1 |
| 1 | 1 | 1 | 1 | 1 | 1 | 1 | 1 | 1 | 1 |

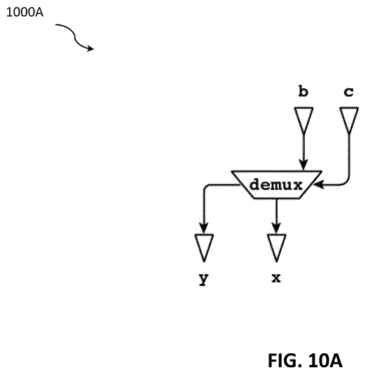

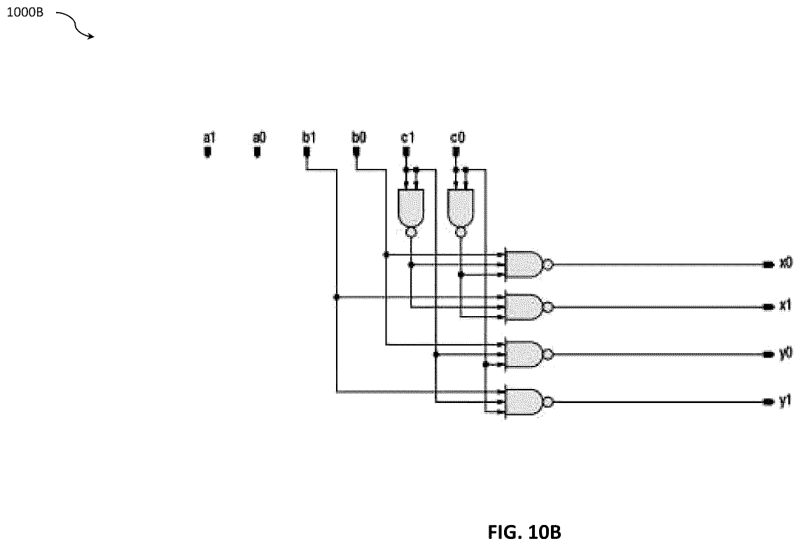

FIG. 10A illustrates a demux microcell 1000A of the microcell library, in accordance with an embodiment of the present disclosure. In an embodiment, the demux microcell 1000A may be configured to perform a demultiplexing operation to either output a first output operand x equal to a second input operand b from the three input operands a, b and c in case the third input operand c is equal to “0”. In an embodiment, the demux microcell 1000A may be configured to output the second output operand y equal to the second input operand b in case the third input operand c is equal to “3”. In an embodiment, the first input operand a is left unconnected. In an embodiment, the three input ports of the two input operands b and c and the two output ports x and y are connected as:

$$c = select \qquad ( 57 )$$

$$b = data\_in \qquad ( 58 )$$

$$x = data\_out \_ 0 \qquad ( 59 )$$

$$y = data\_out \_ 1 \qquad ( 60 )$$

FIG. 10B illustrates an exemplary implementation of a 2-bit demux microcell using NAND gates, in accordance with an embodiment of the present disclosure. In an embodiment, the functional semantics of the 2-bit demux microcell 1000B may be represented by the following logic:

$$if ( c = 0 ) , x = a \qquad ( 61 )$$

$$else if ( c = 3 ) , y = a \qquad ( 62 )$$

Table 9 below provides a truth table for the input b1, b0, c1, and c0 and corresponding output x1, x0, y1, and y0 for demux operation.

TABLE 9

| b1 | b0 | c1 | c0 | y1 | y0 | x1 | x0 |
|---|---|---|---|---|---|---|---|
| 0 | 0 | 0 | 0 | 0 | 0 | 0 | 0 |
| 0 | 0 | 1 | 1 | 0 | 0 | 0 | 0 |
| 0 | 1 | 0 | 0 | 0 | 0 | 0 | 1 |
| 0 | 1 | 1 | 1 | 0 | 1 | 0 | 0 |
| 1 | 0 | 0 | 0 | 0 | 0 | 1 | 0 |
| 1 | 0 | 1 | 1 | 1 | 0 | 0 | 0 |
| 1 | 1 | 0 | 0 | 0 | 0 | 1 | 1 |
| 1 | 1 | 1 | 1 | 1 | 1 | 0 | 0 |

In an embodiment, each of the two outputs of the microcells of the microcell library may be latched to registers which may be synchronized with respect to clock cycle.

Further, the microcells 200A, 300A, 400A, 500A, 600A, 700A, 800A, 900A, 1000A may be implemented for valency of, but not limited to, 2-bits, 4-bits, a byte, a half-word (16-bits), a word (32 bits) and so on to create microcell library comprising microcells 100 for various valencies.

In an embodiment, the microcells 200A, 300A, 400A, 500A, 600A, 700A, 800A, 900A, 1000A may be further utilized to emulate various combinational topologies operable at various valencies implemented.

Table 10 below depicts area-latency characterization of the microcells 200A, 300A, 400A, 500A, 600A, 700A, 800A, 900A, 1000A for valencies at pair, nibble and byte implemented using open-source digital ASIC implementation flow OpenLane using sky130 fd_sc_hd standard cell library.

TABLE 10

| | | | Area (μm²) | | | Latency (n sec) |
|---|---|---|---|---|---|---|
| Block | 2-bit | 4-bit | 8-bit | 2-bit | 4-bit | 8-bit |
| logic | 330 | 430 | 630 | 30 | 30 | 30 |
| shift | 330 | 430 | 630 | 30 | 30 | 30 |
| mask | 330 | 430 | 630 | 30 | 30 | 30 |
| padd | 450 | 920 | 12,680 | 30 | 50 | 60 |
| psub | 450 | 920 | 12,680 | 30 | 50 | 60 |
| pmlt | 1,180 | 5,620 | 24,320 | 60 | 120 | 220 |
| comp | 80 | 160 | 320 | 90 | 150 | 250 |
| mux | 180 | 340 | 660 | 20 | 20 | 20 |
| demux | 180 | 340 | 660 | 20 | 20 | 20 |

The area estimates may be reduced by a factor of almost two and a half when implemented using subscalar computing methodology as disclosed in details in the concurrently filed Indian patent applications titled “System and Method for Implementation of Computational Logic Using Digital VLSI Systems” and “Data Path Elements For Implementation Of Computational Logic Using Digital VISI Systems” the IEEE paper titled “Novel VLSI Architectures and Micro-Cell Libraries for Subscalar Computations” each incorporated herein in entirety by reference.

Accordingly, the implementation of computational logic using subscalar methodology may preserve the data width and by processing smaller fragments of full-width data gainfully to reduce the complexities either in space, or time, or both.

The subscalar computational logic implements an overlapped execution of data-dependent or independent plurality of atomic operations. A subscalar computing unit (not shown) may perform various atomic operations which may be based on one or more logical computational logics such as addition, subtraction, multiplication, shift, mux, de-mux, etc. implemented using microcell library of the present disclosure to output a resultant data. The throughput achieved in the subscalar computation methodology is approximately five time units per iteration which is comparatively lesser than the throughput achieved using conventional computation methodologies which also have throughput with latency of up to nine time units per iteration.

It may be noted, the computational logic may be implemented using electronic design and automation (EDA) tools by providing optimized pre-defined layouts using standard logic gates having various fan-ins and fan-outs defined as the microcell library which may include, but not limited to, logic microcell 200A, shift microcell 300A, mask microcell 400A, padd microcell 500A, psub microcell 600A, pmlt microcell 700A, compare microcell 800A, mux microcell 900A and demux microcell 1000A. In the instant disclosure, the computational logic using subscalar methodology may be implemented using the custom logic blocks of the microcell library which may be better suited in VLSI automated design flows. The micro-cells 200A, 300A, 400A, 500A, 600A, 700A, 800A, 900A, 1000A may be connected in various combinations and topologies to create useful arithmetic and logic modules which may include but not limited to adders, subtractors, shifters, multiplexers, demultiplexers, comparators, and the like, from which complete data-paths may be synthesized.

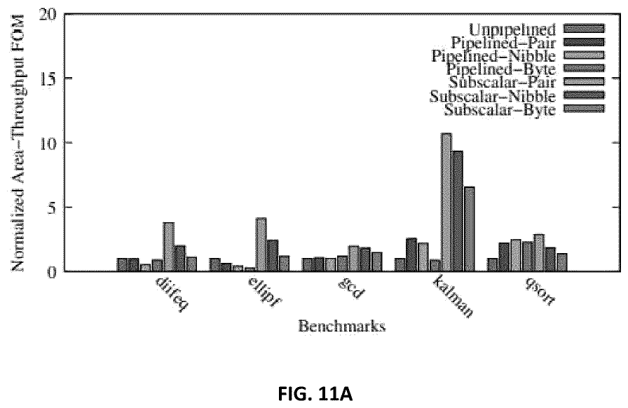

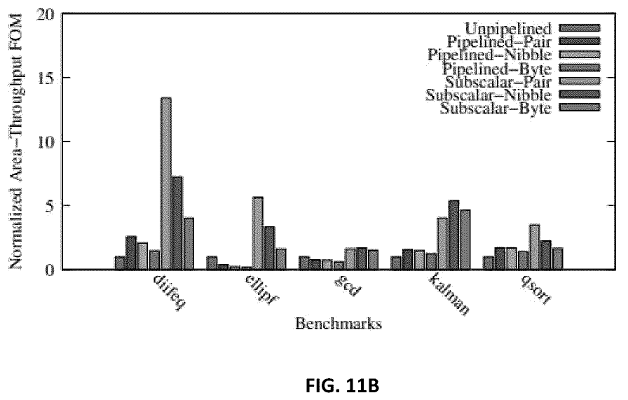

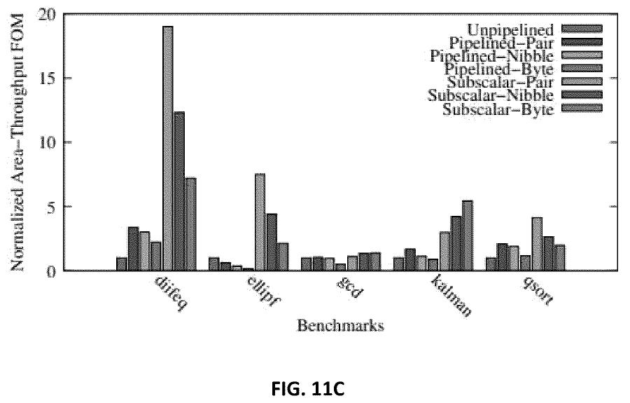

As known to a person skilled in the relevant background art that for very large scale integrated circuits (VLSI), control flow implementation may be required. This requirement may be fulfilled by using comparators (comp), multiplexers (mux), and demultiplexers (demux). Micro-cells like ‘comp’, ‘mux’, and ‘demux’ may be provided and used especially for such VLSI control-flow applications. FIG. 11A, FIG. 11B and FIG. 11C illustrates area-throughput figure-of-merit (FOM) for the unpipelined, pipelined, and subscalar implementations at pair, nibble, and byte valencies of the chosen benchmark circuits are plotted as histograms for an 8-bit, 16-bit, 32-bit datapath widths, in accordance with an experimental embodiment of the present disclosure.

In an embodiment, the subscalar computations using the microcell library may have the following advantages including new data-path synthesis methodology of a partial processing of data at a sub-word boundary. The micro-cell library may be used at an intermediate level of complexity and functionality between standard gates and macro cells. All the cells in the library may have a 3-input 2-output interface which may be implemented as hardwired circuits or as lookup tables or even as coarse grain reconfigurable logic. Further, the designs of a few commonly used datapath elements may be composed of elements chosen from the proposed micro-cell library including microcells 200A, 300A, 400A, 500A, 600A, 700A, 800A, 900A, 1000A. Also, the new EDA tools may be developed which may be adapted to be used in reconfigurable devices.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate micro-cells or data path element may be performed by the same micro-cells or data path element. Hence, references to specific functional units are only to be seen as references to suitable means for providing the described functionality, rather than indicative of a strict logical or physical structure or organization.

Although the present invention has been described in connection with some embodiments, it is not intended to be limited to the specific form set forth herein. Rather, the scope of the present invention may not be limited only by the claims. Additionally, although a feature may appear to be described in connection with embodiments, one skilled in the art would recognize that various features of the described embodiments may be combined in accordance with the invention.

Furthermore, although individually listed, a plurality of means, elements or process steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category as claimed in claims does not imply a limitation to this category, but rather the feature may be equally applicable to other claim categories, as appropriate.

What is claimed is:

1. A microcell library, comprising:
a plurality of microcells,
wherein each of the plurality of microcells implements a primitive logic and has a uniform interface with three input operands at an input interface and two output operands at an output interface, wherein the two output operands, for each of the plurality of microcells, in a clock cycle is latched to one or more output registers of the corresponding microcell,
wherein each of the plurality of microcells is configured to perform one of:
a partial arithmetic operation based on the three input operands
to generate the two output operands, or a logical operation based on at least two of the three input
operands to generate at least one of the two output operands, and
wherein each of the three input operands and each of the two output operands have a uniform pre-defined valency.

2. The microcell library as claimed in claim 1, wherein the uniform pre-defined valency is selected from a pair (2-bits), a nibble (4-bits), a byte (8-bits), a halfword (16-bits), or a word (32 bits).

3. The microcell library as claimed in claim 1, wherein an implementation of each of the plurality of microcells is pipelined or unpipelined.

4. The microcell library as claimed in claim 1, wherein one or more of the plurality of microcells are combined for performing the partial arithmetic operation or the logical operation at a valency higher than the pre-defined valency.

5. The microcell library as claimed in claim 1, wherein at least one of the plurality of microcells is configured to perform a logic operation, wherein
for performing the logic operation, the at least one of the plurality of microcells is configured to perform a bit-wise logic operation on at least one of a first input operand and/or a second input operand based on a third input operand to output a first output operand of the two output operands based on the bit-wise logic operation and a second output operand of the two output operands as a copy of the third input operand.

6. The microcell library as claimed in claim 5, wherein the bit-wise logic operation is one of:
a complement of one of the first input operand or the second input operand, an AND of the first input operand and the second input
operand, an OR of the first input operand and the second input
operand, or
an EX-OR of the first input operand and the second input operand respectively in case the third input operand is Boolean value of 0, 1, 2, or 3 respectively.

7. The microcell library as claimed in claim 1, wherein at least one of the plurality of microcells is configured to perform a bit-wise shift operation, wherein
for performing the bit-wise shift operation, the at least two output operands are a bit-wise left shift of a second input operand from the three input operands based on a number of bit-positions represented by a third input operand from the two outputs.

8. The microcell library as claimed in claim 1, wherein at least one of the plurality of microcells is configured to perform a mask operation, wherein
for performing the mask operation, the at least one of the plurality of microcells are configured to output a corresponding bit value of a first input operand of the three input operands as a first output operand from the two output operands based on a place value specified by a second input operand from the three input operands.

9. The microcell library as claimed in claim 1, wherein at least one of the plurality of microcells is configured to perform a partial addition operation, wherein
for performing the partial addition operation, the at least one of the plurality of microcells are configured to output the sum of the three input operands as the two output operands, wherein a first output operand from the two output operands represents the sum output, and wherein a second output operand from the two output operands represents a carry-out of the sum.

10. The microcell library as claimed in claim 1, wherein at least one of the plurality of microcells is configured to perform a partial subtraction operation, wherein
for performing the partial subtraction operation, the at least one of the plurality of microcells are configured to output a difference by subtracting a second input operand and a third input operand from a first input operand from the three input operands, wherein a first output operand from the two output operands represents the difference output as 2's compliment and wherein a second output operand from the two output operands represents a borrow out of the difference output.

11. The microcell library as claimed in claim 1, wherein at least one of the plurality of microcells is configured to perform a partial multiply-add operation, wherein
for performing the partial multiply-add operation, the at least one of the plurality of microcells are configured to output a product of a first input operand and a second input operand added to a third input operand from the three input operands, wherein a first output operand from the two output operands represents a lower half significant bits of the output, and wherein a second output operand from the two output operands represent an upper half significant bits of the output.

12. The microcell library as claimed in claim 1, wherein at least one of the plurality of microcells is configured to perform a compare operation, wherein
for performing the compare operation, the at least one of the plurality of microcells are configured to:
output the first output operand as “0” in case a first input operand is equal to a second input operand from the three input operands and in case a third input operand from the three input operands is equal to “0”, or output the first output operand as “1” in case a first input operand is greater than the second input operand or in case the first input operand is equal to the second input operand and the third input operand is equal to “1”, or
output the first output operand as “2” in case the first input operand is less than the second input operand or in case the first input operand is equal to the second input operand and the third input operand is equal to “2”.

13. The microcell library as claimed in claim 1, wherein at least one of the plurality of microcells is configured to perform a multiplexing operation, wherein
for performing the multiplexing operation, the at least one of the plurality of microcells are configured to:
output a first output operand from the two output operands equal to a first input operand from the three input operands in case a third input operand from the three input operands comprises “0” in each place values, or
output the first output operand equal to a second input operand from the three input operands in case the third input operand comprises “1” in each place values, and
output the second output operand equal to the third input operand from the three input operands.

14. The microcell library as claimed in claim 1, wherein at least one of the plurality of microcells is configured to perform a de-multiplexing operation, wherein
for performing the de-multiplexing operation, the at least one of the plurality of microcells are configured to:
output a first output operand from the two output operands equal to a first input operand from the three input operands in case a third input operand from the three input operands comprises “0” in each place values, or
output a second output operand from the two output operands equal to the first input operand in case the third input operand comprises “1” in each place values.
